(19) United States
(12) Patent Application Publication
(10) Pub. No.: US 2008/0155635 A1
(43) Pub. Date: Jun. 26, 2008

(54) System and/or method for high-definition media distribution

(75) Inventors: Sam Johnson, Las Vegas, NV (US); Angelo Palmisano, Crystal Lake, IL (US)

Correspondence Address: NIXON & VANDERHYE, PC, 901 NORTH GLEBE ROAD, 11TH FLOOR, ARLINGTON, VA, 22203, US

(73) Assignee: PALTRONICS, INC., Crystal Lake, IL (US)

(21) Appl. No.: 12/068,899

(22) Filed: Feb. 13, 2008

(51) Int. Cl. H04N 7/173

(52) U.S. Cl. 725/118

(57) ABSTRACT

The exemplary embodiments described herein relate to a high-definition media distribution system for use in connection with a media distribution network. At least one HD media source is provided. A plurality of non-HD media sources is provided. A media vault has access to the plurality of non-HD media sources. At least one HD streamer is configured to decode an HD signal from at least one said HD media source and re-encode the HD signal as a streamable HD signal capable of being sent from an Ethernet connection on the at least one HD streamer to the media distribution network. At least one player is configured to receive media signals sent across the media distribution network from the at least one HD streamer and/or the media vault and to cause at least one said HD display and/or at least one non-HD display to display corresponding media content.

### TECHNICAL FIELD

The exemplary embodiments described herein relate to systems and/or methods for media distribution and, more particularly, to systems and/or methods for high-definition media distribution. In certain exemplary embodiments, an HD media source is decoded, streamed across a network in a streamable format, and re-displayed in an HD or other format. Additional processing may be performed on the decoded signal in certain exemplary embodiments, such that additional content may be distributed in connection with an HD or non-HD version of the original content.

### BACKGROUND AND SUMMARY

High-definition (HD) media has become more and more prevalent over the past few years. The prevalence of HD media has expanded yet further, in part, because of the FCC's mandate related to the inclusion of digital tuners in new televisions and an “analog switch-off” bill passed by the U.S. Congress. As used herein, HD media relates to a digital media with a greater resolution than that of traditional television systems, such as, for example, NTSC, SECAM, PAL, and/or the like. HD media typically is broadcast in a 16:9 aspect ratio. The most common HD media formats are 1080i (1,080 actively-interlaced lines of resolution), 1080p (1,080 progressively-scanned lines of resolution), and 720p (720 progressively-scanned lines of resolution). The 1080i and 1080p formats typically feature resolutions of 1920×1080 pixels, while the 720p format typically features a resolution of 1280×720 pixels. Generally, 480p media is not classified as HD media because it is considered by some to lack a sufficiently high enough quality to be considered “true” or “real” HD, although it is sometimes considered “enhanced” media insofar as the format is an improvement over the traditional analog formats noted above.

Patrons at a wide variety of locations—such as, for example, restaurants, bars, casinos, shopping areas, airports, government agencies, etc.—are drawn to HD displays. In addition to the normal attraction to media offerings, the added appeal of HD media may be attributed to one or more of a number of factors, including, for example, the enhanced quality of the media, the oftentimes more novel presentation in the 16:9 aspect ratio, the glossy finishes provided on many HD displays, the interesting “flat screen” LCD, plasma, and/or other displays, etc.

In response to the increased prevalence of HD media and user attraction to HD displays, many media system providers and many location proprietors have sought to update existing displays and media systems, provide more HD displays to existing HD media systems, integrate existing media systems and newer HD systems, etc., for example, to attract more attention and/or patrons.

A typical HD media system is based around the arrangement shown in FIG. 1, which is a conventional link between an HD media source 102 and an HD display 106. The HD media source 102 may be, for example, a set-top box (e.g., which typically is a hardware device that is capable of receiving or “tuning in” an HD television broadcast), an HD player (e.g., an HD DVD player, program logic capable of playing HD video clips, a computer, etc.), and/or the like. The HD display 106 may be any display capable of displaying HD media, such as, for example, an LCD screen, a plasma television, a tube display, etc.

The HD media source 102 includes a first HD port 104, and the HD display 106 includes a second HD port 108. Typically, the HD media source 102 and the HD display 106 are connected via an HDMI (High-Definition Multimedia Interface) cable. HDMI is a licensable audio/video connector interface for transmitting uncompressed, encrypted digital streams, which may be used to connect digital rights management (DRM) enforcing digital audio/video sources.

Although HDMI provides a high-quality interface with optional DRM features, HDMI cables are expensive, difficult to manufacture, and typically come in short sizes. Also, HD media sources frequently have to be placed proximate to, or incorporated directly into, the displays themselves. These disadvantageous aspects of HDMI present challenges to media system providers, for example, in terms of positioning peripherals, running extensions, controlling costs of media systems, ensuring forwards and backwards compatibility, etc.

To overcome at least some of these challenges of HDMI, several solutions have been developed. For example, FIGS. 2a and 2b show typical HDMI extension systems. More particularly, FIG. 2a is a typical HDMI extension system that converts an HDMI cable to two Cat-5 cables attachable to a display device 106′, and FIG. 2b is a typical HDMI extension system that converts an HDMI cable to two Cat-5 cables and then converts the two Cat-5 cables back to an HDMI cable for connection to a display device 106. In FIG. 2a, the HDMI cable from the HD port 104 of the HD media source 102 is connected to an HDMI port 204 of an extender 202. The extender 202 includes hardware configured to convert the HDMI cable to two Cat-5 cables. This typically is accomplished by splitting the signal from the HDMI cable and distributing that signal among the copper in the two Cat-5 cables connected to the two Cat-5 ports 206a-b. Cat-5 cables are less expensive than HDMI cables and are easier to procure and/or manufacture in long sizes. As shown in FIG. 2a, an HD display 106′ may be configured to accept the two Cat-5 cables via two respective Cat-5 ports 208a-b and then display the HD media. However, many displays do not incorporate such ports or are not configured to accommodate such connections. Accordingly, in FIG. 2b, a second extender 202′ is provided so as to accept the two Cat-5 cables from the Cat-5 ports 206a-b of the first extender 202 into its own respective Cat-5 ports 206a′-b′. It may rejoin the split signals from the copper in the Cat-5 cables into an HDMI signal, and then send the output to the HDMI port 108 of the HD display 106 via its HD port 204′. It will be appreciated that a single type of extender 202 may be used to accomplish such features, for example when, in an extender 202, the HDMI port 204 and the Cat-5 ports 206a-b are bidirectional.

Unfortunately, these types of extenders have not solved all of the problems associated with the implementation of HD media and/or have introduced other problems. For example, only one HD signal may be sent per extender. Thus, although a single set-top box may be capable of receiving multiple channels, it typically is necessary to include one extender per HD display and set-top box pair. This presents practical wiring challenges, introduces complexity in the media system, poses difficulties filtering channels from a single HD tuner or set-top box, etc. Also, although Cat-5 cables are being used, because HD media streams require a large amount of bandwidth, it currently is possible to send only 1-2 pure HD streams across a network. In part, this is because the Cat-5 cables are being used only for their copper, and not for any network connectability. Thus, current extenders do not compress, decode, recode, transcode, or otherwise process the HD streams in any way other than the trivial processing required to share the HD signal across two Cat-5 cables. Similarly, further hardware and/or software modules are required to provide enhanced media features, such as, for example, media layering, retransmission, etc. Integration with existing media distribution systems also tends to be cumbersome.

Thus, it will be appreciated that there is a need in the art for improved HD media distribution techniques. It also will be appreciated that there is a need in the art for techniques that overcome one or more of these and/or other drawbacks.

One aspect of certain exemplary embodiments relates to the ability to take the HD media content coming out of a set-top box or its equivalent that normally is attached to a display in a 1:1 ratio and enable streaming across a multitude of displays. Advantageously, this may reduce (and sometimes even completely eliminate) the requirement for a set-top box for each display, while also allowing for additional processing to add content, etc., along the delivery path of such HD media.

Another aspect of certain exemplary embodiments relates to the ability to reduce (and sometimes even completely eliminate) the need for an HD decoding type device inside HD displays, which typically are designed to be hardwired via HDMI cables and connect directly to the LCD glass. Advantageously, it is possible to reduce costs while also adding new functionality.

In certain exemplary embodiments, a high-definition media distribution system for use in connection with a media distribution network is provided. At least one HD media source is provided. At least one HD streamer is configured to decode an HD signal from at least one said HD media source (and which may later be output such HD source via the HDMI or similar port of the decoder box) and re-encode the HD signal as a streamable HD signal capable of being sent from an Ethernet connection of the at least one HD streamer to the media distribution network. At least one HD player is configured to receive a streamable HD signal sent across the media distribution network and to cause at least one HD display to display content corresponding to HD media from at least one said HD media source. The content corresponding to HD media from the at least one HD media source is displayable (along with any other media content that might be added along the media distribution path) on a display connected to the media distribution network substantially in real-time.

In certain exemplary embodiments, a media vault may be provided, with the media vault also possibly including HD content represented as a stored file and then blended with the HD signal. Further, two or more live HD streams (not stored in vault) may be blended together along the media distribution network. Still further, additional HD media content may be stored locally at the edge device or player to blend such media content (e.g., live and/or stored) based on predefined events or triggers (e.g., from a slot machine, based on time or an even, an emergency notification, etc.).

In certain exemplary embodiments, a high-definition media distribution system for use in connection with a media distribution network is provided. At least one HD media source is provided. A plurality of non-HD media sources is provided. A media vault has access to the plurality of non-HD media sources. At least one HD display for displaying media from at least one said HD media source and/or the non-HD media sources is provided. At least one non-HD display for displaying media from at least one said HD media source and/or the non-HD media sources is provided. At least one HD streamer is configured to decode an HD signal from at least one said HD media source and re-encode the HD signal as a streamable HD signal capable of being sent from an Ethernet connection on the at least one HD streamer to the media distribution network. At least one player is configured to receive media signals sent across the media distribution network from the at least one HD streamer and/or the media vault and to cause at least one said HD display and/or at least one non-HD display to display corresponding media content.

In certain exemplary embodiments, a method of distributing media in a high-definition media distribution system for use in connection with a media distribution network is provided. HD media is received from at least one HD media source. An HD signal is decoded from HD media received from the at least one said HD media source and the HD signal is re-encoded as a streamable HD signal. A streamable HD signal is sent from an Ethernet connection on at least one HD streamer to the media distribution network. At least one HD player is associated with at least one HD display. There is received on at least one HD player a streamable HD signal sent across the media distribution network for displaying, substantially in real-time, content corresponding to HD media from at least one said HD media source based on the streamable HD signal received by the at least one HD player on the associated HD display.

In certain exemplary embodiments, an HDMI/IP streamer is provided. An HDMI port is configured to receive HD signals corresponding to HD media content and/or is connectable to an external display to cause the external display to display streamable HD signals corresponding to HD media content. An Ethernet port is configured to send and/or receive streamable HD signals corresponding to HD media content. Decoding programmed logic circuitry is configured to decode received HD signals. Re-encoding programmed logic circuitry is configured to re-encode received HD signals as streamable HD signals. Transmitting programmed logic circuitry is configured to transmit streamable HD signals to a media distribution network via the Ethernet port. Displaying programmed logic circuitry is configured to cause an external display connectable to the HDMI port to display received streamable HD signals.

These exemplary features, aspects, and advantages may be combined in various combinations and ways to achieve yet further embodiments.

### BRIEF DESCRIPTION OF THE DRAWINGS

These and other features, aspects, and advantages will be better and more completely understood by reference to the following detailed description of exemplary illustrative embodiments in conjunction with the drawings, of which:

FIG. 1 is a conventional link between an HD media source and an HD display;

FIG. 2a is a typical HDMI extension system that converts an HDMI cable to two Cat-5 cables attachable to a display device;

FIG. 2b is a typical HDMI extension system that converts an HDMI cable to two Cat-5 cables and then converts the two Cat-5 cables back to an HDMI cable for connection to a display device;

FIG. 3 is a simplified schematic view of an HDMI-IP streaming system in accordance with an exemplary embodiment;

FIG. 4a is a more detailed view of an HDMI-IP streaming system in accordance with an exemplary embodiment;

FIG. 4b is an alternative arrangement to the more detailed view of the HDMI-IP streaming system of FIG. 4a in accordance with an exemplary embodiment;

FIG. 4c is another alternative arrangement to the more detailed view of the HDMI-IP streaming system of FIG. 4a in accordance with an exemplary embodiment;

FIG. 5 is an illustrative schematic view of how HD media may be displayed in accordance with an exemplary embodiment; and

FIG. 6 is an illustrative gaming environment incorporating an HDMI-IP streaming system in accordance with an exemplary embodiment.

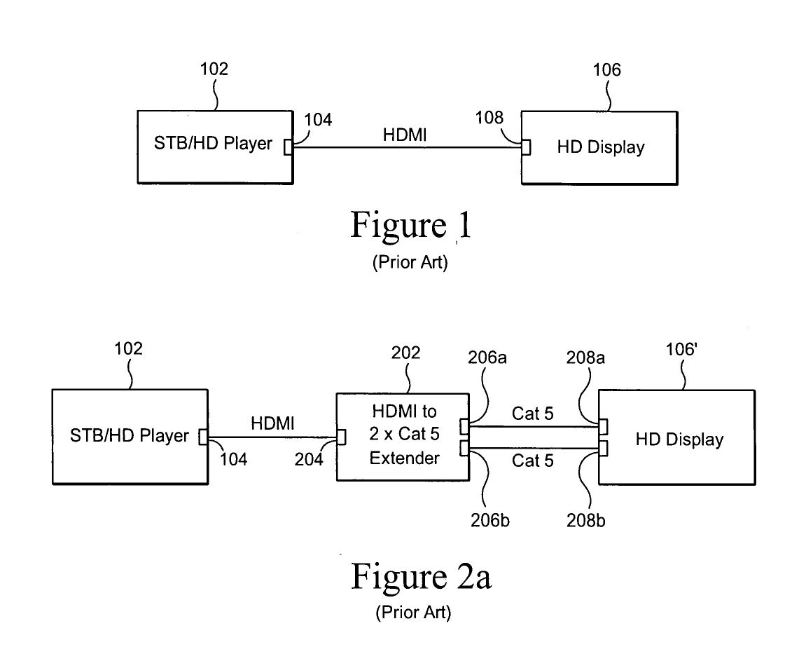

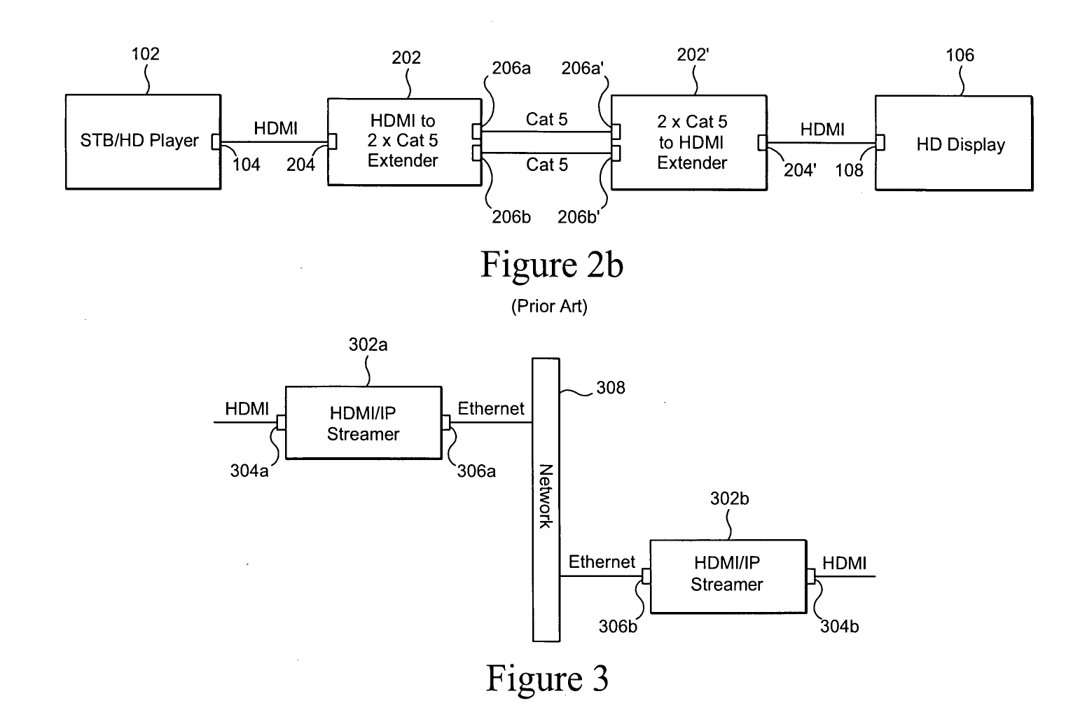

### DETAILED DESCRIPTION

The exemplary embodiments described herein relate to a high-definition media distribution system for use in connection with a media distribution network. At least one HD media source is provided. A plurality of non-HD media sources is provided. A media vault has access to the plurality of non-HD media sources. At least one HD display for displaying media from at least one said HD media source and/or the non-HD media sources is provided. At least one non-HD display for displaying media from at least one said HD media source and/or the non-HD media sources is provided. At least one HD streamer is configured to decode an HD signal from at least one said HD media source and re-encode the HD signal as a streamable HD signal capable of being sent from an Ethernet connection on the at least one HD streamer to the media distribution network. At least one player is configured to receive media signals sent across the media distribution network from the at least one HD streamer and/or the media vault and to cause at least one said HD display and/or at least one non-HD display to display corresponding media content.

Also, in certain exemplary embodiments, an HDMI/IP streamer is provided. An HDMI port is configured to receive HD signals corresponding to HD media content and/or is connectable to an external display to cause the external display to display streamable HD signals corresponding to HD media content. An Ethernet port is configured to send and/or receive streamable HD signals corresponding to HD media content. Decoding programmed logic circuitry is configured to decode received HD signals. Re-encoding programmed logic circuitry is configured to re-encode received HD signals as streamable HD signals. Transmitting programmed logic circuitry is configured to transmit streamable HD signals to a media distribution network via the Ethernet port. Displaying programmed logic circuitry is configured to cause an external display connectable to the HDMI port to display received streamable HD signals. It will be appreciated that in certain exemplary embodiments other content may be mixed into the signal before it reaches the display, with such content being, for example, another live HD source, content stored in a media vault (described in greater detail below), etc.

Referring now more particularly to the drawings, FIG. 3 is a simplified schematic view of an HDMI-IP streaming system in accordance with an exemplary embodiment. In FIG. 3, an HDMI signal is provided to a first HDMI/IP streamer 302a via the first HDMI port 304a. The HDMI signal may be from any suitable source, such as, for example, a set-top box, a DVD player, a personal computer, cable or satellite feed, etc. The HDMI/IP streamer 302a includes decoding programmed logic circuitry (e.g., any suitable combination of hardware, software, firmware, and/or the like) for at least temporarily decoding the HDMI signal. By way of example and without limitation, the HDMI signal may be provided to the HDMI/IP streamer 302a as a MPEG-4 stream, an MPEG-2 stream, or any other suitable format capable of supporting HD signals.

After the stream is decoded, it may be encoded in a different format so that the data can be streamed to one or more displays across a network 308. To this end, the HDMI/IP streamer 302a includes an Ethernet port 306a for communicating this streamable data to the network 308. The streamable data may be provided in any suitable format, and changes may be made to the HD signal itself. For example, in certain exemplary embodiments, it is possible to convert a 1080p or 1080i signal into a 720p signal to save bandwidth and make the data more streamable, e.g., by reducing the amount of data to be streamed across the network. Additionally, or in the alternative, the signal may be compressed using any suitable compression technique, which may or may not be lossless. Thus, although the initial HD signal is modified, in certain exemplary embodiments, the streaming HD signal may still be considered an HD signal. By way of example and without limitation, the signal may be re-encoded into a streaming signal, such as, for example, a streaming MPEG (e.g., MPEG-2 or MPEG-4) signal, a transcoded signal, etc. The encoding process optionally may include an encryption process. Example transcoding techniques are disclosed in, for example, co-pending and commonly-assigned application Ser. No. 11/896,913, the entire contents of which are hereby incorporated herein. Example light-weight encryption techniques are disclosed in, for example, co-pending and commonly-assigned application Ser. No. 11/896,913, the entire contents of which are hereby incorporated herein.

The decoding of the signal and any further processing thereof (such as, for example, re-encoding, encryption, and/or the like) may be performed substantially in real-time (e.g., as close to real-time as possible). For example, an HDMI signal corresponding to a television channel being broadcast in full 1080p may be decoded, converted to 780p, compressed, and encoded into a streamable format substantially in real-time. Thus, the HDMI/IP streamer 302a will introduce little to no latency into the system, apart from normal network operating conditions.

In addition to re-encoding into a streamable HD format, the HDMI/IP streamers of certain exemplary embodiments may optionally encode the HD media into a non-HD stream. Streaming non-HD media generated from an HD media source may be advantageous in certain illustrative implementations, for example, where media is being sent to non-HD displays, such as, for example, older televisions, computers, casino gaming machines, and/or the like. Thus, as alluded to above, the HDMI/IP streamers of certain exemplary embodiments may produce both HD media streams as well as non-HD media streams.

Referring once again to FIG. 3, once the streaming HD signal is sent across the network 308 (which may be a TCP/IP mediated network in certain exemplary embodiments), the underlying content may be displayed by a suitable display connected to the network 308. The display may be an HD display and/or require an HDMI input. In such a case, a second HDMI/IP streamer 302b may be provided proximate to the appropriate display. The second HDMI/IP streamer 302b may receive the streaming HD signal via a second Ethernet port 306b. Once received, the streaming HD signal may be sent to the display via the second HDMI port 304b.

The second HDMI/IP streamer 302b may perform processing on the received streaming HD signal before and/or during transmission to the appropriate display. For example, the second HDMI/IP streamer 302b may need to re-encode the streaming signal into an appropriate signal for transmission over HDMI, for example, by re-encoding it as MPEG-4 data, decompressing the data, decrypting the data, etc. Also, by way of example and without limitation, interlaced media may be converted to progressive scan media. Similar to the first HDMI/IP streamer 302a, the second HDMI/IP streamer 302b may provide data to the display substantially in real-time. As a whole, then, the system shown in FIG. 3 provides HD media from HD sources to HD and/or non-HD displays substantially in real-time. In certain exemplary embodiments, the second HDMI/IP streamer also may attach directly to a display (e.g., the glass itself bypassing the internal HDMI decoding that it does on a typical LCD) without requiring the signal to be re-encoded by the programmed logic circuitry included inside the display if it were otherwise connected directly to the HDMI port of the display.

It will be appreciated that the HDMI/IP streamers of certain exemplary embodiments may include bidirectional ports such that the HDMI/IP streamer(s) proximate to the HD media source(s) may be interchangeable with the HDMI/IP streamer(s) proximate to the HD display(s). Alternatively, or in addition, separate input and output ports may be provided to a single HDMI/IP streamer for both the HDMI connections and the Ethernet connections to reduce the need for differently manufactured “input” and “output” streamers.

In certain exemplary embodiments, as will be described in greater detail below, additional content may be introduced to complement or supplement the original HD signal. In brief, the inclusion of additional content apart from the HD stream may be accomplished using programmed logic circuitry provided to the HDMI/IP streamer, or it may be added by another component in connection with the network 308 and/or the displays. For example, it will be appreciated that additional processing of additional content may take place at one or more locations along the media distribution chain (e.g., at the head-end, at a media bank controller, and/or down to the end display or edge device). As such, it may be possible for two or more displays to have the same main HD content, but to allow each display to have unique content (e.g., by mixing directly at the display-level).

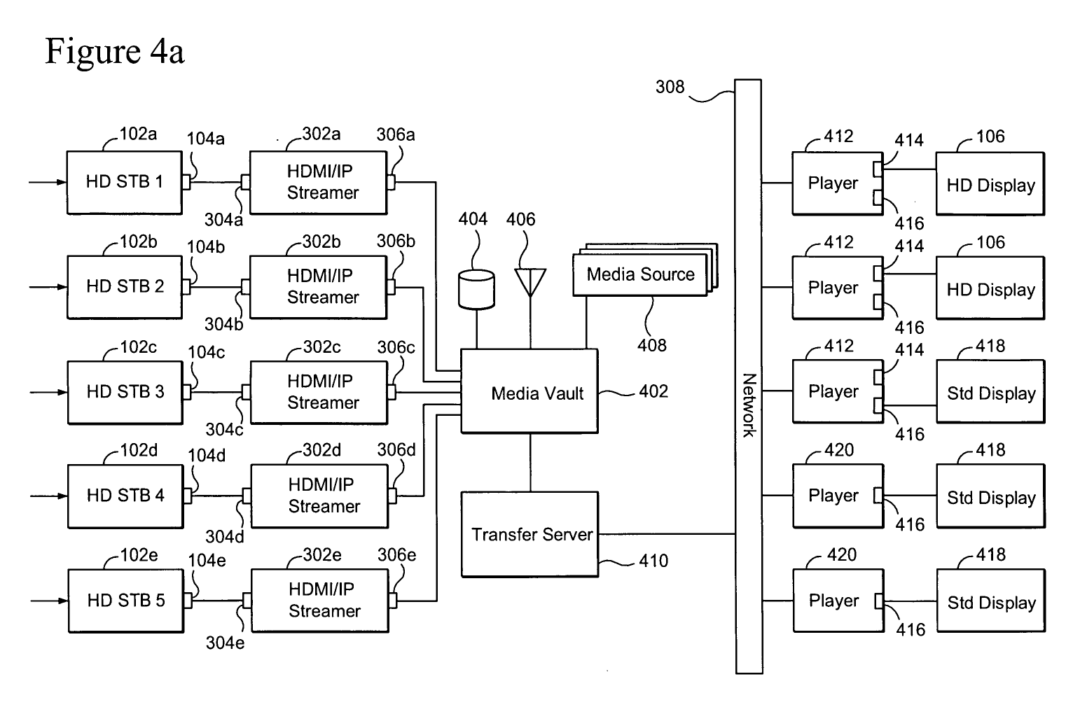

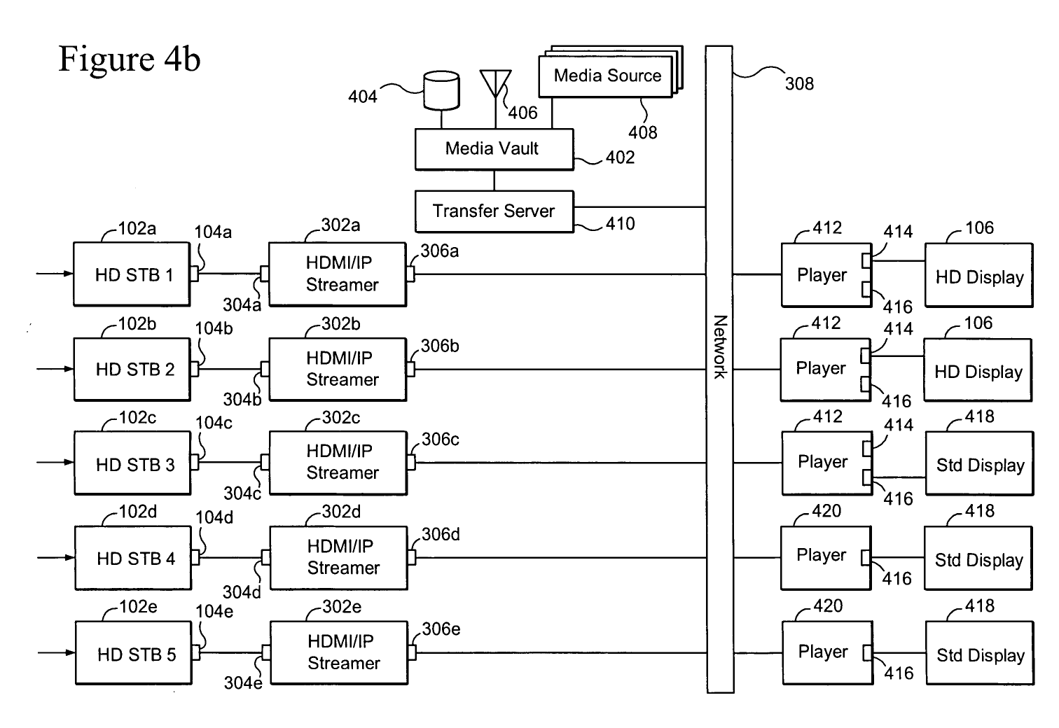

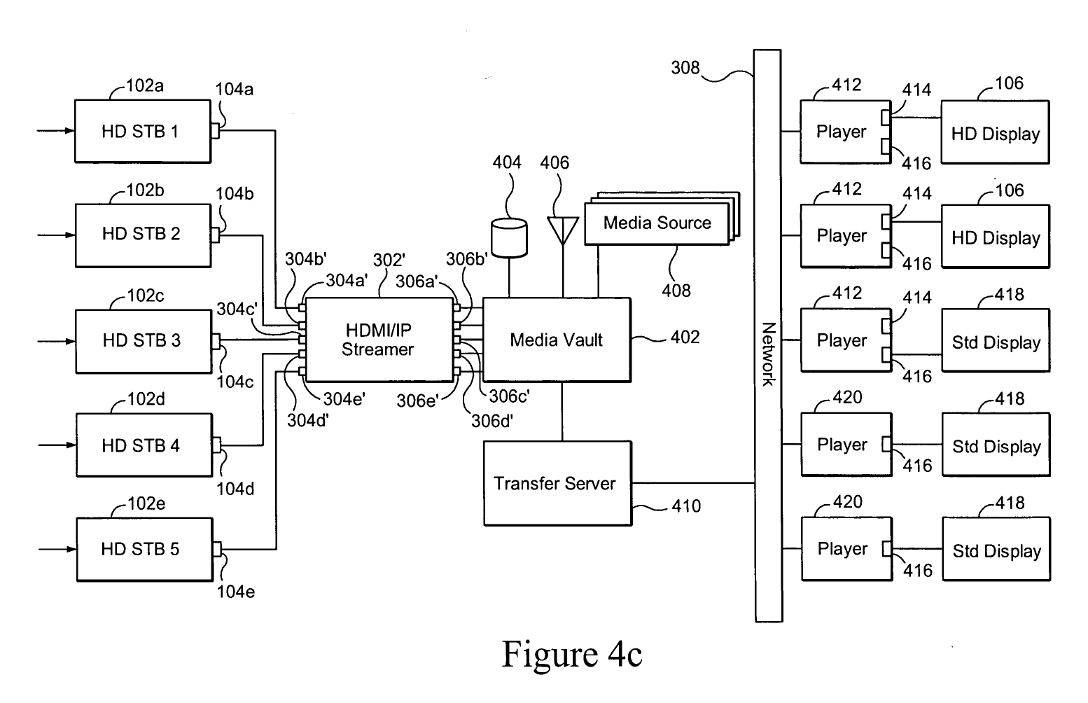

FIG. 4a is a more detailed view of an HDMI-IP streaming system in accordance with an exemplary embodiment. In FIG. 4a, a plurality of HD media sources 102a-e are provided. Each HD media source 102 may correspond to different HD channels, HD movies, HD video clips, and/or the like. Via the respective HDMI ports 104a-e, the HD media sources 102a-e respectively are connected to HDMI/IP streamers 302a-e, optionally located proximate to the HD media sources 102a-e, that are respectively provided with HDMI ports 304a-e.

As noted above, each HDMI/IP streamer 302 converts the HD media source into a streaming HD signal for transmission across the network. To this end, the HDMI/IP streamers 302a-e send streaming HD media to a media vault 402 via respective Ethernet connections 306a-e. The media vault 402 is a repository for, or intermediary to, a variety of different media sources. For example, the media vault 402 may be in connection with a database 404 storing canned or generatable content, such as animations, advertisements, menus, and/or the like. The media vault 402 also may be in connection with one or more broadcast receivers 406 for receiving, for example, standard television broadcast content, cable content, satellite content, closed-circuit content, and/or the like. It also may be connected in certain exemplary embodiments to a semantic engine to make decisions as to what media files to mix in, e.g., based on a set of business rules that when applied to the data coming from the current activity on the gaming floor, the resulting mixed image may be dynamic and/or different depending upon the data received from the gaming activity. Other media sources 408 also may be in connection with the media vault 402. Other media sources 408 may include, for example, videos playable from DVD and/or video tape players, computers, etc.

The media vault 402 is in communication with a transfer server 410. The transfer server 410 mediates traffic between players 412/420, streamers 302, the media vault 402, one or more sources 404/406/408 connected to the media vault 402, etc. For example, the transfer server 410 may respond to requests from players for content by retrieving content from the media vault 402, by tuning in a different station on a particular streamer 302, providing an instruction to layer-in additional generatable content from a computer (not shown) such as a ticker connected to the media vault 402 in connection with an HD or non-HD media stream, etc. By way of example and without limitation, the transfer server may mediate communications via a UDP connection with the network 308. Of course, it will be appreciated that other communications protocols may be used in connection with other exemplary embodiments. In general, the communications between these and/or other components and the transfer servers may be classified as media-related exchanges.

A plurality of displays are provided in the system shown in FIG. 4a. Some of the displays are HD displays 106, whereas some of the displays are standard displays 418. Each display is connected to an improved player 412 or a standard player 420. The players 412/420 are connected to the network 308 and are responsible for retrieving content provided to the network 308, e.g., via the media vault 402. The players 412/420 also may be responsible for layering content onto a display, e.g., by requesting content from the media vault 402 or other network component (e.g., a progressive jackpot controller in a gaming environment that may provide the amount of a progressive jackpot, etc.). Furthermore, an improved player 412 may include, or simply may be, an HDMI/IP streamer 302. Thus, HD content may be provided to an HD display via an improved player 412.

As noted above, each display is connected to an improved player 412 or a standard player 420. Both the improved players 412 and the standard players 420 are connected to the network 308. An improved player 412 may incorporate an HDMI port 414 for connection to an HD display 106, as well as a standard connector 416 (which may be, for example, a composite port, a component video port, an S-video port, and/or the like) for connection to a standard display 418. Thus, incorporating improved players 412 may promote compatibility with older displays, displays not capable of receiving HD media, and/or displays where the presentation of HD media would not be practical (e.g., displays of a poor resolution, where there is little action such as screens with scores, betting lines, or the like, etc.), etc. By contrast, a standard player 420 may only include a standard connector 416 (e.g., of the type(s) described above) for connection with a standard display 418.

FIG. 4b is an alternative arrangement to the more detailed view of the HDMI-IP streaming system of FIG. 4a in accordance with an exemplary embodiment. FIG. 4b is similar to FIG. 4a, except that the HDMI/IP streamers 302a-e are connected directly to the network 308 via their respective Ethernet ports 306a-e. This arrangement may be advantageous in certain non-limiting implementations. For example, it may help reduce strain on the media vault 402 and/or the transfer server 410 by reducing the number of direct connections with these components. Thus, the connection between the media vault 402 and the network 308 may not become as bogged down, suffer any latencies which may or may not be introduced, etc. Moreover, the streaming HD content may be provided more directly to the players 412 and thus the HD displays 106, thereby potentially improving the substantially real-time re-broadcast of the HD media content. In such cases, in certain exemplary embodiments, the players 412 more proximate to the displays 106 may provide an increased role in coordinating requests from the media vault 402 and/or layering in content provided directly or indirectly by media vault 402 or a resource connected thereto.

FIG. 4c is another alternative arrangement to the more detailed view of the HDMI-IP streaming system of FIG. 4a in accordance with an exemplary embodiment. The arrangement shown in FIG. 4c is similar to that of FIG. 4a. However, only a single HDMI/IP streamer 302′ is provided. The single HDMI/IP streamer 302′ includes a plurality of HDMI ports 304a′-e′ for accommodating signals from each of the HD media sources 102a-e. Similarly, the single HDMI/IP streamer 302′ includes a plurality of Ethernet ports 306a′-e′ for connection with the media vault 402. It will be appreciated that on the Ethernet side, it is not always necessary to have a 1:1 ratio of HD ports to Ethernet ports. Yet, it may be advantageous in certain exemplary embodiments to have a 1:1 ratio of HD ports to Ethernet ports to distribute the load and/or separate the HD content out onto separate networks, for example, rather than combining them all into one Ethernet port. In a similar variation (not shown), a single HD set-top box may be connected to a single HDMI/IP streamer configured to broadcast all or a user-configured set of channels received by the single HD set-top box.

In another variation (not shown), the HDMI/IP streamers 302a-e may be in connection with the transfer server 410 but not the media vault 402 so as to provide a control mechanism (e.g., transfer server 410) for the distribution and/or layering of content (e.g., HD content, ancillary content separate from the particular HD content being streamed, etc.). In such cases, the transfer server 410 may function as normal, but instead of relaying HD content through the media vault 402, it may provide it directly to the network 308 for display on an appropriate HD display 106.

Streaming HD media may be displayed in a number of different ways when received by a display. For example, the streaming HD media may be displayed “as-is,” e.g., without any further processing. In such a case, for example, if 1080p media is converted to a 720p stream for the purposes of transmission across the network, the media may be displayed as 720p media. In other cases, it may be advantageous to modify the streaming media prior to and/or during display. For example, if 1080p media is converted to a 720p stream for the purposes of transmission across the network, the media may be up-converted to 1080p for display purposes.

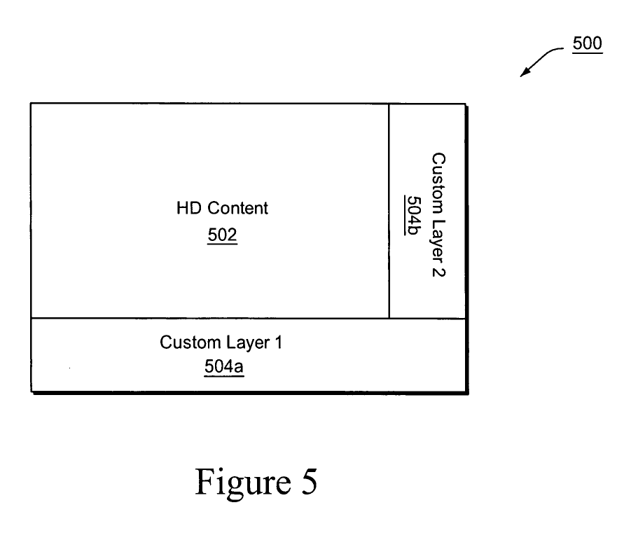

As another example, custom content (e.g., custom layers) may be added to the stream. For example, FIG. 5 is an illustrative schematic view of how HD media may be displayed in accordance with an exemplary embodiment. The display 500 may be divided into HD content area 502, and first and second custom layers 504a-b may be added. By way of example and without limitation, if the streaming HD content is received as 720p media for display on a 1080p screen, the layers may be added to adjacent edges of the stream so that the combination of the streaming HD content and the layers occupy all of the 1080p display. In other cases, the custom layers may conceal a part of the streaming HD media. Of course, the configuration shown in FIG. 5 is provided by way of example and without limitation. For example, more or fewer layers may be provided in the same or in different positions and/or sizes. In general, HD media from at least one said HD media source is displayable by at least one HD display in a format different from a native format thereof (e.g., in terms of layering, sizing, resolution, and/or the like).

Indeed, it will be appreciated that the content of the screen may vary in dependence on any number of factors. For example, if the display is to be used in a restaurant, wait times, prices, seating areas, waitlists, and/or other information may be displayed. In a sports bar, game-related information such as scores, statistics, and/or the like may be displayed. In a casino, jackpot amounts, special event information, ball drop information for Bingo/Keno games, betting lines, etc., may be displayed. In certain exemplary embodiments, the content to be displayed may be configured by a user using programmed logic circuitry. Such programmed logic circuitry may be in connection with one or more of the player, the display, the media vault, the HD media source, etc.

Further content may be provided as one or more floatable layers. Floatable layers are described in for example, co-pending and commonly-assigned application Ser. Nos. 11/889,970 and 11/889,971, the entire content of each of which are hereby incorporated herein by reference.

As noted above, in some cases, it may be possible to display the streaming HD media on a non-HD display, e.g., via the player. This feature advantageously may promote integration with existing systems, enable older components to be installed into newer systems, etc. In other circumstances, display of HD content may not necessarily be desirable. For example, a user may not be able to detect minor variations on a small display or on a display from which a user's attention is easily lost.

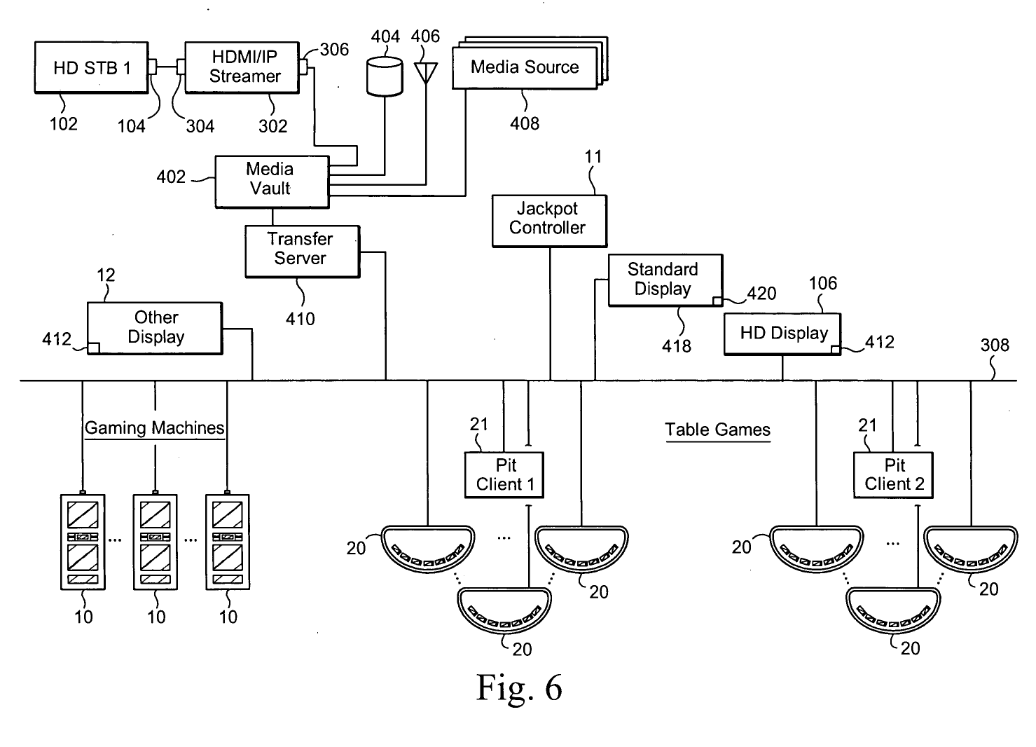

FIG. 6 is an illustrative gaming environment incorporating an HDMI-IP streaming system in accordance with an exemplary embodiment. FIG. 6 shows a plurality of gaming machines 10, a plurality of table games 20, and associated peripherals being located on a casino floor and being connected in a networked environment. For aesthetic purposes, belly glass often is provided on gaming machines. Each gaming machine includes a first display area, generally referred to as a game screen. The game screen traditionally has been where most of the “action” happens. For example, the game screen may simulate the rolling of the reels on a slot machine and thus indicate whether the user has won any money. A second display area, generally referred to as a top box, also is provided. The top box may display additional information for the patron, such as, for example, advertising, generally entertaining animations, bonus game opportunities, etc.

The game screen and/or the top box may be touch screen monitors and thus accept input directly. Such input may pertain to, for example, the number of credits to bet, the way in which a bet may be made, whether to initiate a bet, whether to cash out, etc. In other cases, a separate control panel (not shown) may be provided to enable the same and/or similar functionality.

The gaming machine also is provided with a player tracking module (PTM) area. The PTM area includes a payment acceptor (e.g., a card reader) to accept payment (e.g., cash, an encoded card storing credits, or the like) from the patron. A small display screen (or PTM) 110 is located in the PTM area and enables the patron to access certain other more individualized services. For example, the PTM may enable the patron to call an attendant to order drinks. In such a case, the PTM may cause the candle (e.g., one or more differently colored lights) of the gaming machine 10 to become lit to signal to casino personnel that the patron is requesting some form of service. The PTM typically is an LCD screen and typically is operated using control panel.

The PTM may have a computer-readable storage medium (not shown) associated therewith. The computer-readable storage medium typically is a small flash drive, hard drive, or other suitable memory location. Information may be distributed to the PTM and at least temporarily stored on the computer-readable storage medium. In this way, it is possible to provide some media offerings to the gaming machine 10 for display by the PTM. More particularly, the computer-readable storage medium is used as a buffer for the media offerings that ultimately may be displayed by the PTM.

The game screen and the top box, and the respective associated circuitry, typically are provided by a single company. The PTM often is provided by another vendor. Sometimes, the PTM will be integrated into the gaming machine 10. However, it is often the case that the gaming machine 10 will be retrofitted with a PTM. As such, the hardware and software systems for the game screen and the top box typically are independent of the hardware and software systems for the PTM.

This separation often makes integration between the various components cumbersome. Thus, to accommodate these features related to the PTM area, gaming machines are equipped with special purpose hardware. It will be appreciated that the player management tracking and information management features provided typically exist outside of the normal base game(s) environment, which deal directly with game play rather than ancillary services, patron interaction, feedback, and the like.

It will be appreciated that although the gaming machines 10 shown in FIG. 6 all appear the same, the present invention is not so limited. A wide variety of gaming machines may be provided, table games, roulette tables, etc. may be provided, in terms of configuration, style, type, functionality, payoffs, etc.

In many cases, an RS-485 connection is utilized. The connection often is to a machine interface card (or MIC) located within each gaming machine. In essence, the MIC translates between the gaming machine 10 and the network 308, making all such gaming machines appear to be the same from the perspective of the network 308.

As alluded to above, a plurality of gaming machines 10 may be located on a casino floor and being connected in a networked environment, e.g., via network 308. To this end, a plurality of central systems (not shown) are connected to the networked environment to collect and/or distribute data, as necessary. Each gaming machine 10 may be connected to one or more of the central systems via a network link. An in-machine meter may be provided to the gaming machines 10 to cooperate with the central systems (e.g., to provide information regarding game plays, amounts of wagers, payoffs, etc.).

It will be appreciated that similar techniques may be applied to table games. Each table 20 has a number of player positions. More particularly, seven player positions are shown, as this is the customary number of player positions at blackjack tables, for example. Of course, the invention is not limited to a particular number of player positions or to any particular table game.

Each player position includes a display and a payment acceptor and/or card reader (similar to the payment acceptor described above in connection with the gaming machines 10). The player may have the ability to place side wagers and/or a main wager via the interface offered by the display. Each player position also includes a MIC and an in-table meter, similar to the components described above with relation to the gaming machines 10.

There also is a dealer terminal provided to each table. The dealer terminal includes a player representation and a keypad. The dealer may use the dealer terminal to make player credits/debits, retrieve the status of any player (e.g., amount of credits, whether the player is a preferred patron, etc.), and the like. For example, the dealer may designate a player in the player representation and indicate, via the keypad, whether to credit/debit the player's account, what the player's hand included, etc.

Data may be logged (e.g., to one or more databases of the central servers) during and/or after the play of each player.

A connection is provided to each table 20 from the network 308 so as to connect each respective table 20 to, for example, the central systems (not shown) and the jackpot controller 11 via a data switch. Via the connection, the data switch connects the dealer terminal to the network 308. Similarly, via the connection, the data switch connects each of the player positions to the network 308.

In certain exemplary embodiments, each table 200 will have its own associated data switch. In such exemplary instances, the network 308 may be kept more “flat” and thus network latencies may be decreased. However, in certain other exemplary embodiments, the player positions and the dealer terminal may be directly addressable across the network 308.

A pit client 21 also sits on the network 308. A pit, or area of table games within a casino, typically comprises 2-12 such tables. There may be multiple pits within a single casino. One or two pit bosses typically are assigned to a pit. In place of or in addition to pit bosses, the pit client 21, via its connection to the central systems and to the tables 20 individually, may provide substantially real-time player ratings. These player ratings may be actual, rather than merely estimated, ratings. In addition to actual and substantially real-time ratings, actual substantially real-time player and table accountings may be gathered. Moreover, promotional and/or contributional bonusing may be provided based on an individual's identity, an individual player's rating, on a particular table's action, on the action within a pit, on a property-wide basis, according to a multi-property basis, etc.

A jackpot controller 11 also is connected to the network 308. A single jackpot controller may be assigned to a bank of gaming machines 10. Typically, 124 gaming machines comprise a bank. The jackpot controller 11 may be responsible for calculating jackpots, changing the turnover on every hit and/or on every play, returning the winning amounts, etc. Although a single jackpot controller 11 is shown on the network, the present invention is not so limited. For example, a jackpot controller 11 or an instance of a jackpot controller 11 may be provided to each pit.

In addition to the gaming machines 10 and the table games 20 existing in the network, one or more overhead displays may be connected to the network 308. The overhead displays may receive data from the central systems indicating, for example, the jackpot amount(s) (e.g., current, daily, monthly, etc.), payouts (e.g., current, daily, monthly, etc.), winners, etc. The overhead displays may be an HD display 106 including an improved player 412, a standard display 418 with a conventional player 420, or another display 12 with a conventional player 412. Although not shown, an improved player 412 or a conventional player 420 may be included directly in a gaming machine 10. Thus, as described above, HD and/or non-HD media content may be sent to any peripheral including a player 412/420 in operable connection with the network 308. The media components of FIG. 6 driving the displays are similar to those shown in and described in connection with FIGS. 4a-c. A single HD media source 102 is shown for the sake of simplicity, and it will be appreciated that a plurality of HD media sources 102 may be used in connection with certain exemplary embodiments.

The techniques of certain exemplary embodiments described herein may be applied to multi-property layouts and/or venues. For example, a master HD media source 102 and master HD streamer 102 may be provided for all of the gaming machines 10, tables 20, and displays, etc., across all of the gaming properties. It also is possible in certain exemplary embodiments to stream media across the public Internet and/or a private network to distribute media to virtually anywhere in the world. Thus, although there may be a master HD media source 102 and master HD streamer 102, there need not be a “master location” in the exemplary embodiment. By contrast, one location in a multi-property system may be designated a master location and include a master HD media source 102 and master HD streamer 102.

In certain exemplary embodiments, each property may have its own HD media source(s) 102 and HD streamer(s) 102. In certain exemplary embodiments, multicast transmissions may be provided within a single, and across multiple, properties. In certain other exemplary embodiments, multicast networks may be provided within each property, but property-to-property communications may take place over a different kind of network (e.g., a unicast, broadcast, or other network). In such cases, a slave site optionally may have programmed logic circuitry to simulate a connection to a master site (e.g., by storing data and imitating responses that would come from the master site) in the event that a connection between properties is lost.

Although certain exemplary embodiments have been described as relating to gaming machines and table games in casinos, it will be appreciated that the present invention is not so limited. For example, the exemplary embodiments described herein may be used in connection with casinos, riverboats, restaurants, hotels, etc.

Furthermore, instead of, or in addition to, content being provided directly on the main screen, top box, and/or PTM of gaming machines, directly on display areas of table games, and/or other information being displayed on overheads, kiosks, and/or the like, it will be appreciated that such content may be displayed and/or redisplayed on one or more floatable layers provided to any gaming device and/or display in the network gaming environment.

Thus, in certain exemplary embodiments, it is possible to stream multiple HD media offerings (e.g., multiple HD channels) simultaneously across the same network. In certain exemplary embodiments, this may be accomplished in place of, or in addition, the transmission of non-HD media offerings across the same network. This may be accomplished by converting HD media into a streamable format, rebroadcasting the HD media in the streamable format, and opening and/or displaying the streaming media HD media for playback on an HD or standard display. Certain exemplary embodiments thus advantageously provide flexibility and simplicity in media network design by reducing the need for HD tuners at each display device, reducing the need for extenders, providing the option of displaying HD content on non-HD displays, providing further content (e.g., layered content) in connection with the HD content, integrating with existing media distribution networks, facilitating connections with older technology even in newer media distribution networks, etc. By way of example and without limitation, it has been found that at least about 5 HD media channels may be streamed simultaneously over a network, in addition to normal media content and other network traffic.

It will be appreciated that in certain exemplary embodiments, the illustrative techniques described herein may be implemented as programmed logic circuitry (e.g., any suitable combination of hardware, software, and/or firmware) and thus may be tangibly stored as instructions on a computer-readable storage medium. Furthermore, in certain exemplary embodiments, the HDMI/IP streamer(s) and/or the end-peripheral devices on which the content is to be displayed may include computer-readable storage mediums (e.g., memory locations, disk drive devices, flash drives, etc.), for example, to at least temporarily store data for, during, and/or after processing.

Although certain example embodiments have been described in connection with high-definition ports being HDMI ports, the present invention is not so limited. Other connectors and ports may be used to transfer HD media, such as, for example, co-ax, component, optical, and/or other cables, and such ports and connectors may be used in connection certain exemplary embodiments of the HD/IP streamers described herein.

It will be appreciated that the exemplary embodiments described herein also may be used in other settings. For example, consumers in the home may stream their HD content to multiple TV's throughout the house and/or to other locations (e.g., neighbors' houses, relatives' houses, schools, nurseries, etc.), with a reduced need for the typically rigid one set-top box per television requirement. Still further, certain exemplary embodiments may enable users to view HD content via a network connection (e.g., the Internet) when away (e.g., at a remote location) by porting into one of these devices.

It also will be appreciated that the exemplary features, aspects, and advantages described herein may be combined in yet further ways to achieve further embodiments.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A high-definition media distribution system for use in connection with a media distribution network, comprising:
at least one HD media source;
at least one HD streamer configured to decode an HD signal from at least one said HD media source and re-encode the HD signal as a streamable HD signal capable of being sent from an Ethernet connection of the at least one HD streamer to the media distribution network; and
at least one HD player configured to receive a streamable HD signal sent across the media distribution network and to cause at least one HD display to display content corresponding to HD media from at least one said HD media source,
wherein the content corresponding to HD media from the at least one HD media source is displayable on a display connected to the media distribution network substantially in real-time.

2. The high-definition media distribution system of claim 1, wherein at least about 5 separate HD channels are streamable across the network simultaneously.

3. The high-definition media distribution system of claim 1, wherein HD media from at least one said HD media source is providable to the at least one HD streamer in 720p format.

4. The high-definition media distribution system of claim 1, wherein HD media from at least one said HD media source is providable to the at least one HD streamer in 1080p or 1080i format.

5. The high-definition media distribution system of claim 4, wherein HD media from at least one said HD media source is displayable by at least one HD display in 720p format.

6. The high-definition media distribution system of claim 1, further comprising layering programmed logic circuitry configured to add custom layer content to content corresponding to HD media from at least one said HD media source.

7. The high-definition media distribution system of claim 1, further comprising a media vault having access to a plurality of media sources different from the at least one HD media source, the at least one streamer being connected to the media vault.

8. The high-definition media distribution system of claim 1, further comprising a transfer server configured to mediate media-related exchanges between the at least one HD media source, the at least one HD player, at least one HD display, and/or the media vault.

9. The high-definition media distribution system of claim 1, further comprising at least one non-HD display configured to display media from the media vault and/or the at least one HD media source.

10. The high-definition media distribution system of claim 9, further comprising a transfer server configured to mediate media-related exchanges between the at least one HD media source, the at least one HD player, at least one HD display, and/or at least one non-HD display.

11. The high-definition media distribution system of claim 1, wherein the at least one HD media source is configured to provides HD media to the at least one streamer via an HDMI connection.

12. The high-definition media distribution system of claim 1, wherein ports provided to the at least one HD streamer are bi-directional ports.

13. The high-definition media distribution system of claim 1, wherein at least one said HD media source is a set-top box.

14. A casino gaming environment including the high-definition media distribution system of claim 1.

15. A high-definition media distribution system for use in connection with a media distribution network, comprising:
at least one HD media source;
a plurality of non-HD media sources;
a media vault having access to the plurality of non-HD media sources;
at least one HD display for displaying media from at least one said HD media source and/or the non-HD media sources;
at least one non-HD display for displaying media from at least one said HD media source and/or the non-HD media sources;
at least one HD streamer configured to decode an HD signal from at least one said HD media source and re-encode the HD signal as a streamable HD signal capable of being sent from an Ethernet connection on the at least one HD streamer to the media distribution network; and
at least one player configured to receive media signals sent across the media distribution network from the at least one HD streamer and/or the media vault and to cause at least one said HD display and/or at least one non-HD display to display corresponding media content.

16. The high-definition media distribution system of claim 15, further comprising layering programmed logic circuitry configured to add custom layer content to media signals sent across the media distribution network from the at least one HD streamer and/or the media vault.

17. The high-definition media distribution system of claim 15, further comprising a transfer server configured to mediate media-related exchanges between the at least one HD media source, the plurality of non-HD media sources, the at least one player, the at least one HD display, the at least one non-HD display, and/or the media vault.

18. The high-definition media distribution system of claim 15, wherein the at least one HD media source is configured to provides HD media to the at least one streamer via an HDMI connection.

19. The high-definition media distribution system of claim 1, wherein ports provided to the at least one HD streamer are bi-directional ports.

20. The high definition media distribution system of claim 1, wherein HD media from at least one said HD media source is displayable by at least one HD display in a format different from a native format thereof.

21. A casino gaming environment including the high-definition media distribution system of claim 15.

22. In a high-definition media distribution system for use in connection with a media distribution network, a method of distributing media comprising:
receiving HD media from at least one HD media source;
decoding an HD signal from HD media received from the at least one said HD media source and re-encoding the HD signal as a streamable HD signal;
sending a streamable HD signal from an Ethernet connection on at least one HD streamer to the media distribution network;
associating at least one HD player with at least one HD display; and
receiving, on at least one HD player, a streamable HD signal sent across the media distribution network for displaying, substantially in real-time, content corresponding to HD media from at least one said HD media source based on the streamable HD signal received by the at least one HD player on the associated HD display.

23. An HDMI/IP streamer, comprising:
an HDMI port configured to receive HD signals corresponding to HD media content and/or connectable to an external display to cause the external display to display streamable HD signals corresponding to HD media content;
an Ethernet port configured to send and/or receive streamable HD signals corresponding to HD media content;
decoding programmed logic circuitry configured to decode received HD signals;
re-encoding programmed logic circuitry configured to re-encode received HD signals as streamable HD signals;
transmitting programmed logic circuitry configured to transmit streamable HD signals to a media distribution network via the Ethernet port; and
displaying programmed logic circuitry configured to cause an external display connectable to the HDMI port to display received streamable HD signals.
